(19) United States
(12) Patent Application Publication
(10) Pub. No.: US 2013/0169103 A1
(43) Pub. Date: Jul. 4, 2013

(54) CONDUCTOR WELD-END FORMING PROCESS

(71) Applicants: Brad Chamberlin, Pendleton, IN (US); Colin Hamer, Noblesville, IN (US)

(72) Inventors: Brad Chamberlin, Pendleton, IN (US); Colin Hamer, Noblesville, IN (US)

(73) Assignee: Remy Technologies, L.L.C., Pendleton, IN (US)

(21) Appl. No.: 13/342,692

(22) Filed: Jan. 3, 2012

(51) Int. Cl. H02K 3/28; H02K 15/08

(52) U.S. Cl. 310/216.001; 29/596

(57) ABSTRACT

A method of joining a plurality of electrical conductors in an electric machine comprises the steps of providing a core with a plurality of circumferentially spaced openings, and positioning a plurality of conductors within the openings of the core in a plurality of concentric layers. Each conductor includes an end that extends from the core. The ends of the conductors have a first shape. The method also includes the step of shaping the ends of the conductors with a set of forming dies to form a second shape. Additionally, the method includes the step of joining a pair of adjacent ends with a joining tool to form a joint with a third shape after shaping the ends to form the second shape. The method further includes the step of removing the set of forming dies and the joining tool from the joint after the joining step.

### BACKGROUND AND SUMMARY OF THE DISCLOSURE

The present invention relates generally to electric machines and, more particularly, to a method of joining the conductors of a stator assembly within electric machines.

Electric machines may be used for a variety of applications, including in connection with power trains for hybrid and internal combustion engine automobiles. For example, an automobile may use an electric machine as a starting motor for an internal combustion engine, or as an alternator to generate electricity and deliver power to vehicle accessories and/or charge a vehicle's battery.

An illustrative electric machine includes a rotor and a stator. The stator is comprised of a stator stack or core, and a plurality of conductors or windings, that are inserted into the stator stack. The windings are interconnected (e.g., welded together) at weld-end turns or joints in order to form a circuit that is necessary for operation of the electric machine. In particular, the electric machine operates when the stator interacts with the rotor through magnetic fields to convert electric energy to mechanical energy, or to convert mechanical energy to electric energy.

Some stators are positioned in small or confined spaces and it may be desirable to reduce the overall package size or height of the stator. For example, the length of the weld-end turns extending from the stator may be reduced to decrease the package size of the stator. However, conventional size-reduction processes that are performed after the ends of the windings have been welded together and the resulting weld-end turns have cooled may cause debris that could contaminate the stator (e.g., metallic shavings from a machining process).

The present disclosure relates to an illustrative method of joining a plurality of electrical conductors in an electric machine. The method comprises the step of providing a core with a plurality of circumferentially spaced openings. The method further comprises the step of positioning a plurality of conductors within the openings of the core in a plurality of concentric layers. The conductors include ends extending from the core in a first layer, a second layer, a third layer, and a fourth layer. The second layer is adjacent to the first layer and is spaced radially outward from the first layer. The third layer is adjacent to the second layer and is spaced radially outward from the second layer. The fourth layer is adjacent to the third layer and is spaced radially outward from the third layer. The first and second layers define an inner winding set, and the third and fourth layers define an outer winding set. The outer winding set is radially spaced apart from the inner winding set. A center space is provided between the inner and outer winding sets. The method also comprises the steps of shaping radially adjacent ends of a pair of conductors of the first and second layers of the inner winding set, and shaping radially adjacent ends of a pair of conductors of the third and fourth layers of the outer winding set. Additionally, the method comprises the steps of joining the radially adjacent ends of the inner winding set to form an inner joint, and joining the radially adjacent ends of the outer winding set to form an outer joint. The method further comprises the step of increasing a radial width of the center space between the inner and outer winding sets.

According to another illustrative method of the present disclosure, a plurality of electrical conductors in an electric machine are joined. The method comprises the step of providing a core with a plurality of circumferentially spaced openings. Additionally, the method comprises the step of positioning a plurality of conductors within the openings in a plurality of concentric layers. An end of each conductor extends in an axial direction from the core. The method further comprises the step of applying pressure to a pair of radially adjacent ends of the conductors with a shaping tool. The method also comprises the step of joining the pair of radially adjacent ends of the conductors with a joining tool to form a joint. The method further comprises the step of removing the shaping tool and the joining tool from the joint.

According to a further illustrative method of the present disclosure, a plurality of electrical conductors in an electric machine are joined. The method comprises the step of providing a core with a plurality of circumferentially spaced openings. Additionally, the method comprises the step of positioning a plurality of conductors within the openings of the core in a plurality of concentric layers. Each conductor includes an end extending from the core. The ends of the conductors have a first shape. The method further comprises the step of shaping the ends of the conductors with a set of forming dies to form a second shape. The method also comprises the step of joining a pair of radially adjacent ends with a joining tool to form a joint having a third shape after shaping the ends to form the second shape. Lastly, the method includes the step of removing the set of forming dies and the joining tool from the joint after the joining step.

According to a further illustrative embodiment of the present disclosure, an electric machine assembly comprises a core extending in a circumferential direction and an axial direction. The electric machine further comprises a plurality of electrical conductors supported by the core. Each electrical conductor has a first portion that extends from the core and a second portion that is positioned within the core. Adjacent first portions of the conductors form a plurality of joints and the joints have a generally circular cross-section. The second portions of the conductors have a generally rectangular cross-section.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a front perspective view of an illustrative stator assembly;

FIG. 2 is a detailed front perspective view of a plurality of electrical conductors of the illustrative stator assembly of FIG. 1, prior to being coupled at weld-end turns or joints through an illustrative method of the present disclosure;

FIGS. 3A and 3B are top views of an illustrative shaping step for cold working adjacent ends of the electrical conductors according to the illustrative method of the present disclosure;

FIGS. 3C and 3D are side views an illustrative joining step for coupling the adjacent ends of the electrical conductors to form a joint following the illustrative shaping step of FIGS. 3A and 3B;

FIG. 3E is a top view of the illustrative joining step of FIGS. 3C and 3D;

FIG. 4A is a side view of an illustrative holding step for supporting adjacent ends of the electrical conductors according to another illustrative method of the present disclosure;

FIGS. 4B-4D are side views of an illustrative joining step for coupling the adjacent ends of the electrical conductors to form a joint following the illustrative holding step of FIG. 4A;

FIGS. 4E and 4F are top views of an illustrative shaping step for hot working the joint following the illustrative joining step of FIGS. 4B-4D;

FIG. 5 is a perspective view of the weld-end joint formed by the illustrative method of the present disclosure;

FIG. 6 is a detailed front perspective view of a pair of weld-end joints of the type shown in FIG. 5;

FIG. 7 is top view of the pair of weld-end joints of FIG. 6 extending from the top of the stator assembly; and

FIG. 8 is a top view of a pair of prior art weld-end joints extending from a stator assembly.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

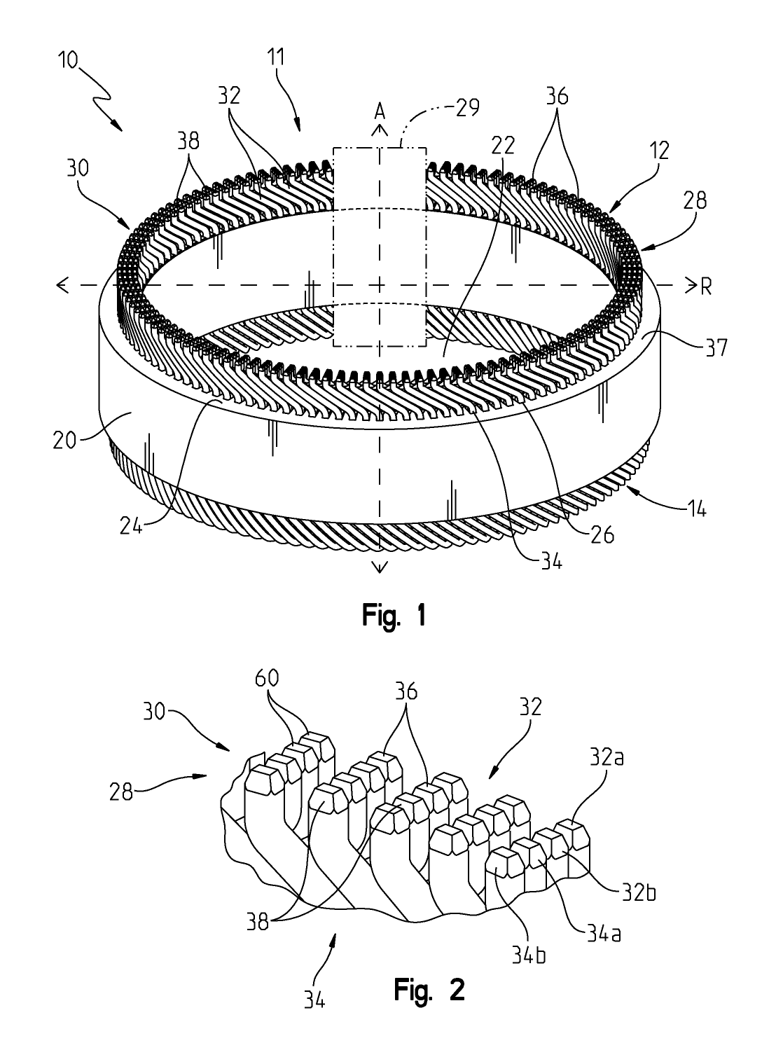

Referring initially to FIG. 1, an illustrative stator assembly 10 of an electric machine 11 is shown. The stator assembly 10 includes an insertion end 14 and a connection end 12. The electric machine 11, when used as a fraction motor for example, includes the stator assembly 10 operably coupled to a rotor (not shown) through magnetic fields in order to convert electric energy to mechanical energy. In a similar manner, the electric machine 11 may also be used as an alternator or generator to generate electricity by converting mechanical energy to electric energy through magnetic fields and delivering power, for example, to vehicle accessories and/or to charge a vehicle's battery.

The stator assembly 10 is illustratively comprised of a core or stator stack 20, and a plurality of electrical conductors or windings 30. The stator stack 20 includes a cylindrical wall 24 and an open center portion 22. An axial direction A extends through the open center portion 22 of the stator stack 20 and a radial direction R is perpendicular to the axial direction A. The cylindrical wall 24 may include one or more lamination stacks or layers (not shown). The cylindrical wall 24 may be comprised of silicon steel to reduce hysteresis and eddy current losses during operation of the electric machine 11. Alternatively, the cylindrical wall 24 may be comprised of a solid powered metal body. Furthermore, the stator stack 20 may include a metal (e.g., steel) frame (not shown).

The cylindrical wall 24 of the stator stack 20 illustratively includes a plurality of circumferentially-spaced, axially-extending slots 26 through which the conductors 30 are received. The slots 26 may include an insulating material (e.g., varnish, foam, gel, spray) (not shown) to fill voids or spaces between the conductors 30 and the cylindrical wall 24 of the stator stack 20, as well as voids between conductors 30. The slots 26 extend between the insertion end 14 and the connection end 12 of the stator stack 20. Each slot 26 each illustratively supports at least a portion of one or more conductors 30.

The stator assembly 10 illustratively includes a commons region 28 and a specials region 29, which are comprised of the conductors 30. The specials region 29 determines the type and configuration of the stator assembly 10. As is known in the art, the specials region 29 may include, for example, neutral conductors, phase conductors, cross-over conductors, and leads for coupling with external electrical components (not shown).

The conductors 30 within the commons region 28 are positioned within slots 26 of the stator stack 20. The conductors 30 may have different maximum voltage capacities (e.g., approximately 120 volts (V)), depending on the function of the stator assembly 10.

Referring to FIG. 2, the illustrative conductors 30 prior to final assembly each have a rectangular cross-section, although other cross-sectional shapes may be substituted therefor. The efficiency of the electric machine 11 may be improved by increasing the slot-fill-ratio (SFR) of the machine 11. The SFR is a comparison of the aggregate cross-sectional area of the conductors 30 in one of the slots 26 and the cross-sectional area of the slot 26 itself. If the electric machine 11 has a high SFR, the cross-sectional area of the conductors 30 reduces the phase resistance and the resistance of the conductors 30 for a given size of the slots 26. Conductors 30 illustratively have a rectangular cross-section, rather than a circular cross-section, received within the slots 26 of the stator stack 20, in order to contribute to a higher SFR for the machine 11. Therefore, the efficiency of the machine 11 may be improved.

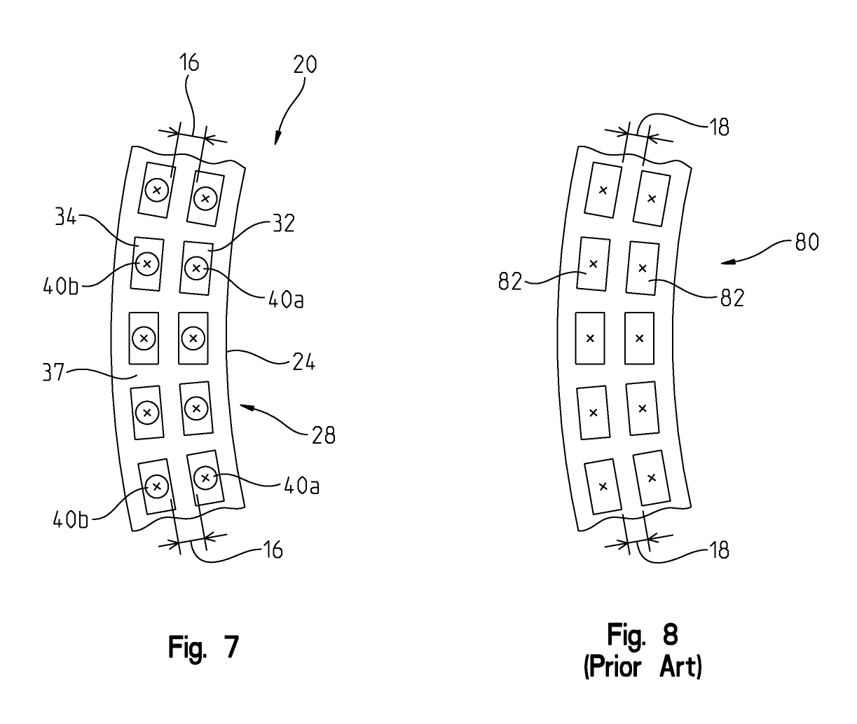

Illustratively in FIGS. 1 and 2, the commons region 28 of the stator assembly 10 includes pairs of inner conductors 32 and pairs of outer conductors 34. The outer conductors 34 are spaced radially outward from the inner conductors 32 to define a center space 16 of the stator stack 20 (FIG. 7). The representative pairs of inner and outer conductors 32, 34 form radially-spaced concentric layers or rings of conductors 30. More particularly, the inner conductors 32 define a first concentric layer 32a of conductors 30 adjacent a second concentric layer 32b of conductors 30. The first concentric layer 32a is adjacent the open center portion 22 of the stator stack 20. The second layer 32b is spaced radially outward from the first concentric layer 32a. Similarly, the outer conductors 34 define a third concentric layer 34a of conductors 30 and a fourth concentric layer 34b of conductors 30. The fourth concentric layer 34b is spaced radially outward from the third concentric layer 34a. A typical stator assembly 10 may include different numbers of conductors 30 (e.g., 120 conductors 30, or 240 conductors 30), depending on the desired power, magnetic, and other operational requirements of the stator assembly 10.

The inner conductors 32 have ends 36 illustratively extending from the connection end 12 of the stator assembly 10 (FIG. 1). Likewise, the outer conductors 34 have ends 38 extending from the connection end 12. For example, the ends 36, 38 of the respective inner and outer conductors 32, 34 may extend approximately 34 millimeters (approximately 1.34 inches) from a top surface 37 of the cylindrical wall 24 of the stator stack 20. Each conductor 30 may be bent or shaped into a more compact configuration during production of the stator assembly 10. The conductors 30 may be shaped according to the teachings of U.S. Pat. No. 6,894,417 to Cai et al., which issued on May 17, 2005, the disclosure of which is expressly incorporated by reference herein. More particularly, the illustrative conductors 30 are bent to form a hairpin-shape, or U-shape, however, the conductors 30 may be bent to form other shapes.

As shown in FIGS. 1 and 2, the ends 36, 38 of the conductors 30 extend from the slots 26 of the stator stack 20 and are staggered, or “interleaved” (i.e., positioned through a different slot 26 with respect to adjacent conductors 30). The ends 36, 38 of the conductors 30 extending from the slots 26 are interconnected to form at least one circuit. For example, the conductors 30 may interconnect to form a single-phase circuit, a two-phase circuit, or a three-phase circuit.

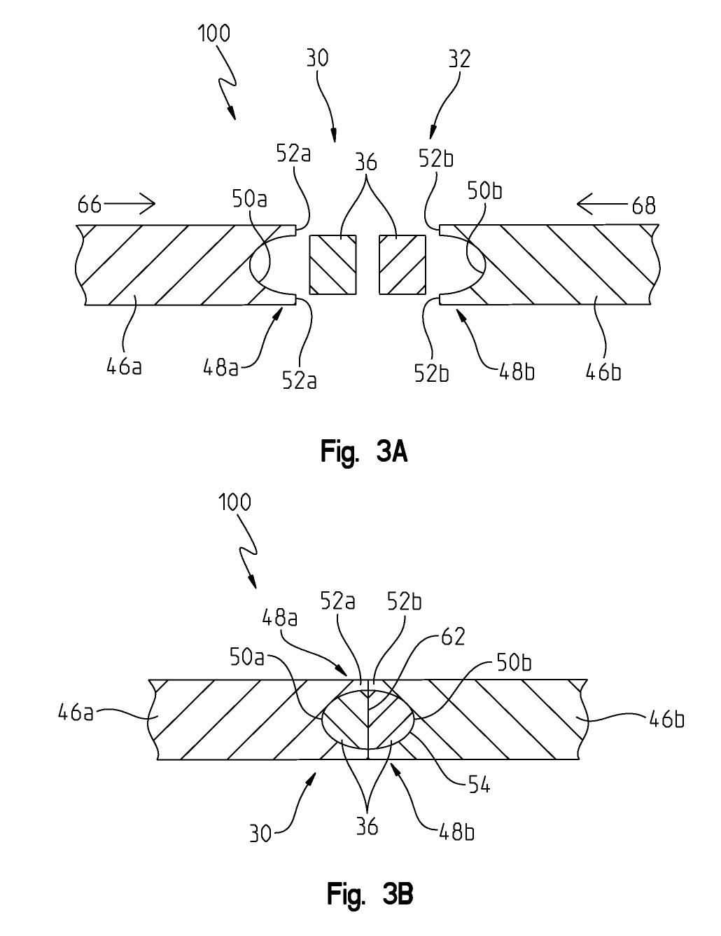

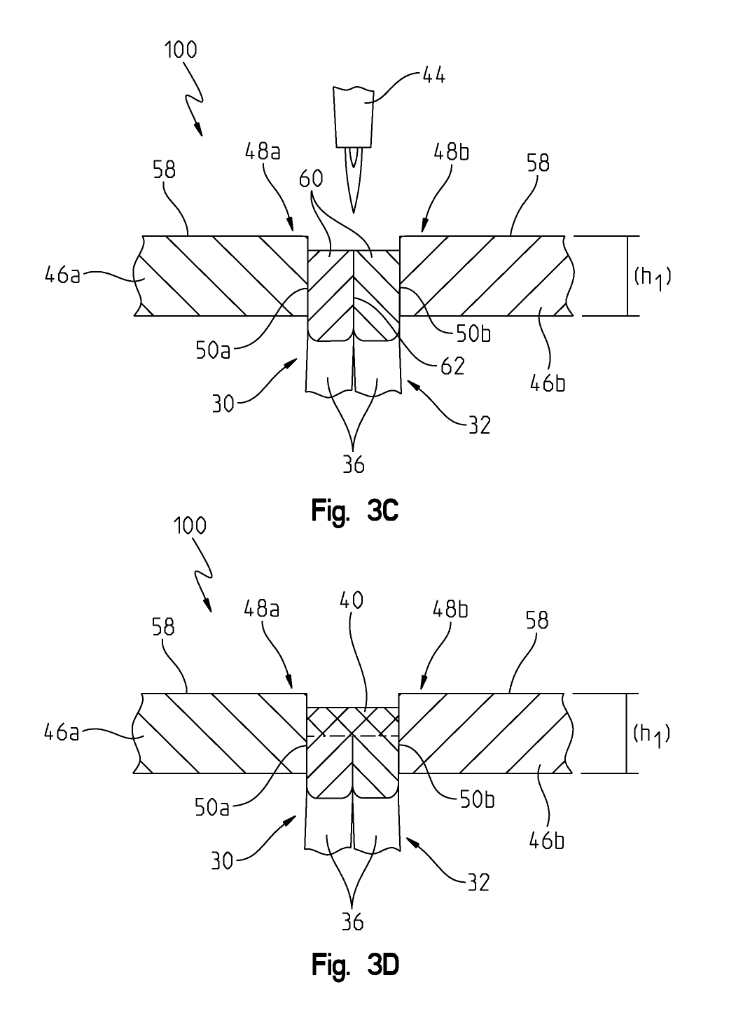

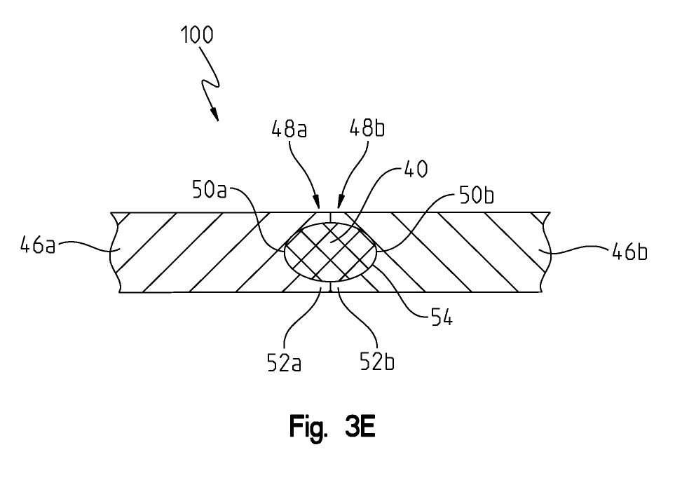

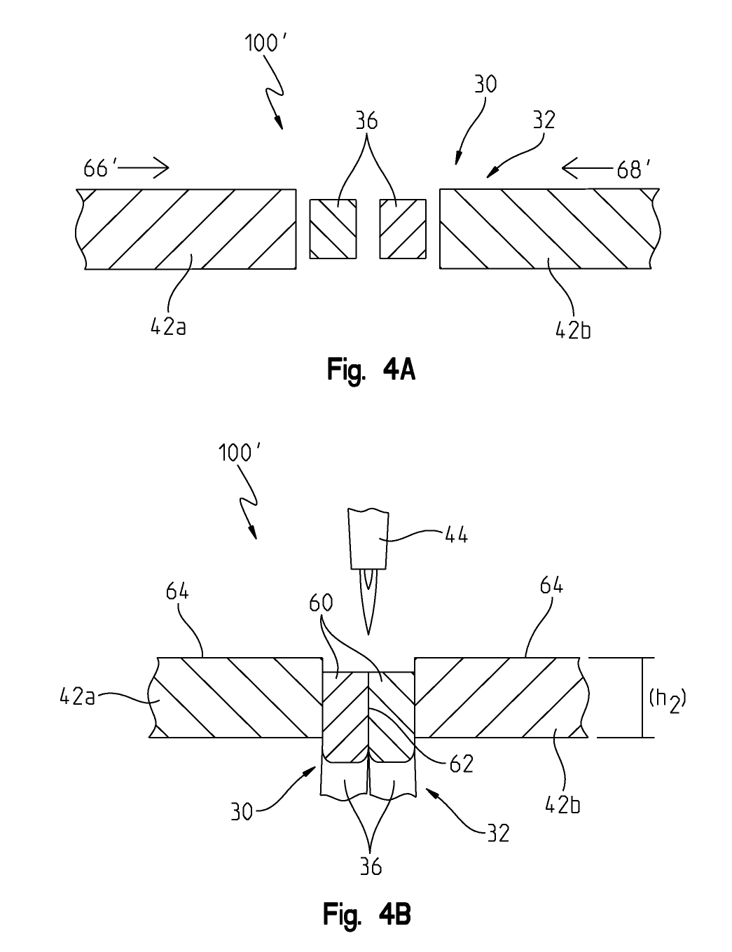

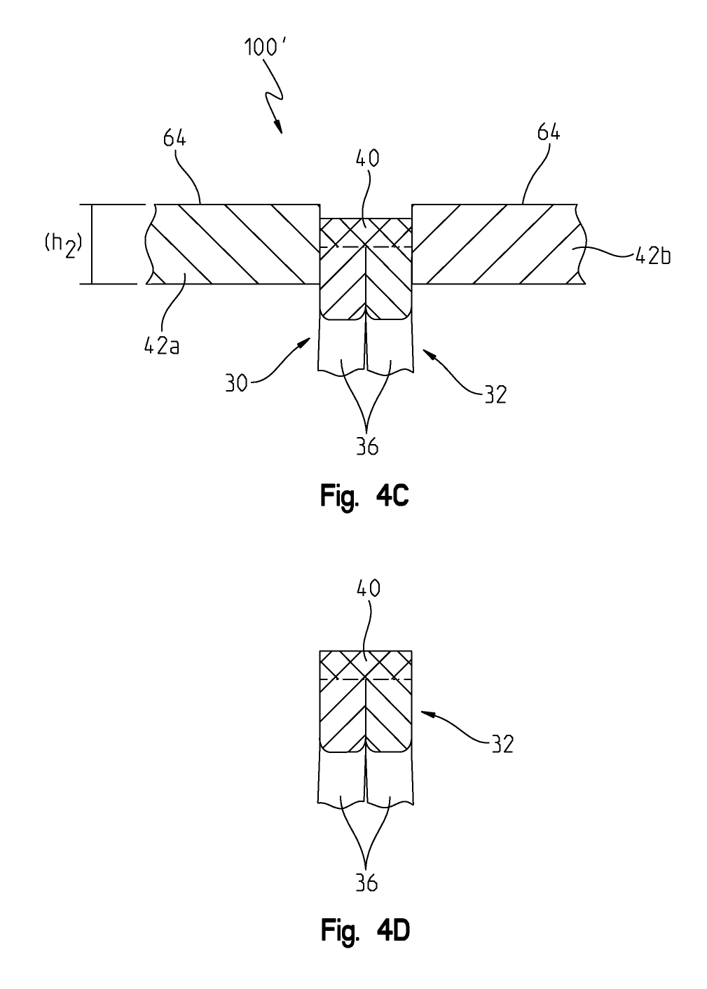

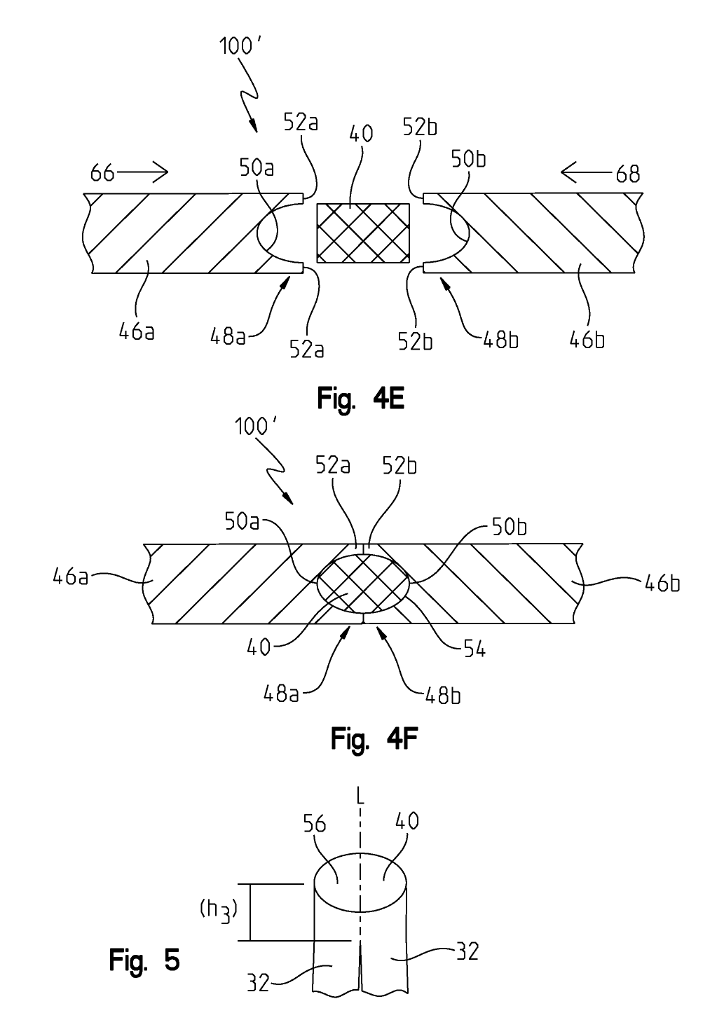

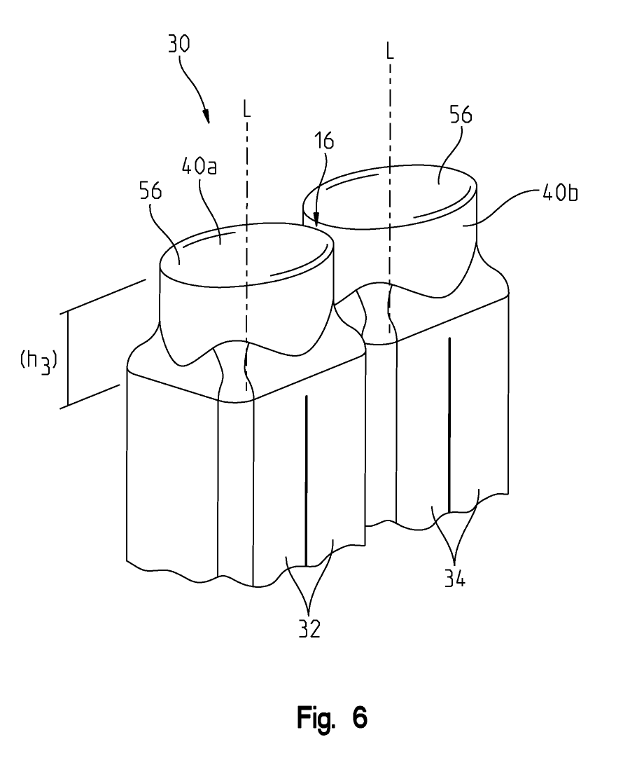

A coupling machine 100 (FIGS. 3A-3E) and a coupling machine 100′ (FIGS. 4A-4F) may be used to join radially adjacent ends 36, 38 of respective conductors 32, 34 to form weld-end turns or joints 40. More particularly, a first plurality of joints 40a may be formed from the inner conductors 32 and positioned adjacent the open center portion 22 of the stator stack 20. Similarly, a second plurality of joints 40b may be formed from the outer conductors 34 and are radially spaced apart from joints 40a. Each joint 40a, 40b has a longitudinal axis L that is substantially parallel to the axial direction A of the stator stack 20. Illustratively, the center space 16 is positioned intermediate the joints 40a, 40b. As further detailed herein, the radial width of the center space 16 may be affected when joints 40a, 40b are formed (FIGS. 6 and 7).

The coupling machines 100 and 100′ may also uniformly size and shape the joints 40 in order to decrease the package size of the stator assembly 10 for easier positioning in small spaces. Additionally, the coupling machines 100 and 100′ may increase the radial width of the center space 16 between the joints 40a and 40b.

According to FIGS. 3A-3E, an illustrative cold-working method of forming the joints 40a may be performed by the illustrative coupling machine 100. The coupling machine 100 includes tools, such as a joining device (illustratively a welding device) and a shaping device (illustratively a pressing device or die). The joining and shaping devices may be operably coupled together or may be individual tools separable from the coupling machine 100. The illustrative coupling machine 100 is shown with reference to inner conductors 32, however, it is to be understood that the outer conductors 34 form joints 40b according to the same illustrative method detailed herein.

According to FIGS. 4A-4F, an illustrative hot-working method of forming the joints 40 may be performed by the illustrative coupling machine 100′. The coupling machine 100′ may include the same or similar joining and shaping devices as the coupling machine 100, and also include additional devices such as a holding device (illustratively a clamping device). The holding, joining, and shaping devices of coupling machine 100′ may be operably coupled together or may be individual tools separable from the coupling machine 100′. The illustrative coupling machine 100′ is shown with reference to inner conductors 32, however, it is to be understood that the outer conductors 34 form joints 40b according to the same illustrative method detailed herein.

Illustratively, as shown in FIGS. 3A-3E, 4E, and 4F, the shaping device of the coupling machine 100 and the coupling machine 100′ may include forming dies 46. More particularly, as shown in FIGS. 3A-3E, 4E, and 4F, a first forming die 46a and a second forming die 46b may be configured to move in opposing directions 66 and 68, respectively, toward ends 36, 38 of the conductors 30 along the radial direction R of the stator stack 20. Actuators, such as springs, hydraulics, or pneumatics, for example, may be used to move the first and second dies 46a, 46b in directions 66, 68. The first and second dies 46a, 46b include inner ends 48a, 48b, respectively, that are proximate the ends 36, 38 of the conductors 30. The inner ends 48a, 48b have complementary profiled or shaped portions 50a, 50b with end surfaces 52a, 52b, respectively. More particularly, the shaped portions 50a, 50b of the dies 46a, 46b are substantially mirror images of each other. For example, the shaped portion 50a is a void or cut-out at the inner end 48a and is positioned intermediate the end surface 52a of the first die 46a. The shaped portion 50b has a similar configuration. Illustratively, the shaped portions 50a, 50b of the respective inner ends 48a, 48b are generally rounded or arcuate, forming a C-shape or a semi-circle, for example. However, it is to be understood that the shaped portions 50a, 50b of the inner ends 48a, 48b may embody other shapes.

When the first and second dies 46a, 46b are brought together along directions 66, 68, the end surfaces 52a, 52b may contact each other to define a stop (not shown) such that the shaped portions 50a, 50b of the inner ends 48a, 48b form a cavity 54. The coupling machines 100 and 100′ may include other limit stops for engaging end surfaces 52a, 52b. In particular, the cavity 54 may form a generally cylindrical shape that illustratively surrounds the ends 36, 38 of the conductors 30. The illustrative cavity 54 is generally round or circular in cross-section, however, it is to be appreciated that cavity 54 may embody other shapes in cross-section. For example, the cavity 54 may define an oval in cross-section having a greater dimension in the circumferential direction (i.e., major axis) than in the radial direction (i.e., minor axis). The height (h₁) of the illustrative first and second dies 46a, 46b may be at least four millimeters (approximately 0.16 inches) (FIGS. 3C and 3D). As such, the depth of the cavity 54 also is at least four millimeters (approximately 0.16 inches).

The joining device of the coupling machine 100 and the coupling machine 100′ is an illustrative welding torch 44 (FIGS. 3C and 4B). The torch 44 may be a plasma torch or any other conventional heating device for melting and welding metals. The illustrative torch 44 may be centrally positioned above the conductors 30 and parallel to the axial direction A of the stator stack 20. Alternatively, the torch 44 may be positioned along a side of the conductors 30. The torch 44 welds together the ends 36, 38 of the conductors 30 in order to form the joint 40.

With reference to the hot-working method of FIGS. 4A-4C, the holding device of the coupling machine 100′ includes supports or holding clamps 42 that hold the ends 36, 38 of the conductors 30 together. In comparison, the coupling machine 100 of the illustrative cold-working method (FIGS. 3A-3E) does not include the holding device. Illustratively, a first holding clamp 42a and a second holding clamp 42b may be configured to move toward the conductors 30 in opposing directions 66′, 68′ along the radial direction R of the stator stack 20. Actuators, such as springs, hydraulics, or pneumatics, for example, may be used to move the first and second holding clamps 42a, 42b in directions 66′, 68′. The height (h₂) of the illustrative embodiment of first and second holding clamps 42a, 42b may be approximately four millimeters (approximately 0.16 inches) (FIGS. 4B and 4C).

The coupling machines 100 and 100′ may be configured to simultaneously join a plurality of pairs of conductors 30 (FIG. 6). The coupling machines 100 and 100′ also may be automated in order to efficiently form the joints 40 of the conductors 30. In one embodiment, the coupling machines 100 and 100′ may be configured to index or rotate circumferentially around the stator assembly 10 to further increase the efficiency of the joining process. In another embodiment, the coupling machines 100 and 100′ may include a rotating support or platform (not shown) to index the stator assembly 10 for this purpose, as well.

Referring to FIGS. 3A-3E, an illustrative cold-working method of interconnecting or joining the ends 36, 38 of the conductors 30 to form a circuit is herein described in the following illustrative steps. The illustrative cold-working method includes a shaping step and a joining step that may be performed by the coupling machine 100. While the illustrative method is described with reference to the inner conductors 32, the outer conductors 34 are joined in the same manner.

During assembly of the stator assembly 10, when the conductors 30 are positioned within the slots 26 of the stator stack 20, the ends 36 of the conductors are joined. The illustrative cold-working method of joining the conductors 30 includes moving the dies 46a, 46b of the coupling machine 100 along directions 66, 68, respectively, toward the ends 36. Illustratively, directions 66, 68 are along the radial direction R, however, directions 66, 68 may be angled relative to the radial direction R in alternative embodiments of the present disclosure.

The inner end 48a of the first die 46a contacts one end 36 of the inner conductors 32 and the inner end 48b of the second die 46b contacts an adjacent end 36 of the inner conductors 32. Illustratively, upper surfaces 58a, 58b of the dies 46a, 46b are positioned approximately one millimeter (0.04 inches) above the tip 60 of the ends 36 of the conductors 30. The dies 46a, 46b exert pressure on ends 36 such that the ends 36 are pushed toward each other to form a contact region 62. More particularly, the ends 36 move toward each other in the radial direction R. It may be appreciated that the ends 38 of the outer conductors 34 also are pushed toward each other in the same manner. Illustratively, the dies 46 move toward each other in a single movement. Alternatively, the dies 46 may be configured to move toward each other in independent and successive iterations of motion. Additionally, the amount of pressure exerted by the dies 46 may change with each successive motion.

The pressure exerted on the ends 36 by the dies 46 is sufficient to cold work the material of the conductors 30. As such, the outer surface or perimeter of the ends 36 deforms and results in ends 36 having the same general shape as the shaped portions 50 of the inner ends 48 of the dies 46. Illustratively, the ends 36 of the inner conductors 32 form a generally semi-circular shape. As the ends 36 are cold-worked, the inner ends 48a, 48b of the respective dies 46a, 46b continue to move toward each other until the respective end surfaces 52a, 52b contact each other. As such, the shaped portions 50a, 50b form the cavity 54 around the cold-worked ends 36 when the end surfaces 52a, 52b contact each other. The illustrative cavity 54 has a generally cylindrical shape (i.e., generally defines a circle in cross-section). The dies 46a, 46b no longer move in directions 66, 68 towards each other once the ends 36 have been deformed to fit within the cavity 54 and the end surfaces 52a, 52b contact each other.

While the inner surfaces of the ends 36 contact each other during the shaping step, the ends 36 are subsequently joined during the illustrative joining step (FIGS. 3C-3E). More particularly, the joining device or tool of coupling machine 100 may be a welding apparatus, illustratively the torch 44, and is positioned above and between the tips 60 of the ends 36 and increases the temperature of the ends 36 to melt and fuse (i.e., weld) the ends 36 together. To prepare the conductors 30 for welding, the ends 36 may be trimmed or otherwise cut or shaped. Additionally, any coating or insulation along the outer surface of the ends 36 may be removed, for example by a stripping process. The ends 36 may also be shaped or otherwise pointed prior to being welded. More particularly, the ends 36 of the conductors 30 are welded together to form the joint 40 (FIGS. 3C-3E, 5, and 6).

Illustratively, the joining step is a standard plasma weld process, however, the joining step may include other fusing or welding process, such as arc welding, CO₂ gas shielded arc welding, and inert gas shielded metal arc welding (i.e., MIG welding). More particularly, the illustrative torch 44 may be operably coupled to a negative electrode of a welding power source (not shown) and is positioned above the ends 36 of the conductors 30. When the welding power source is operating, an inert gas (e.g., argon, helium) is supplied to the torch 44 in order to discharge an arc between the torch 44 and the ends 36 of the conductors. During the joining step, the illustrative torch 44 may be operated at approximately 130 amps for approximately 120 milliseconds to fuse together the ends 36 of the conductors 30.

The illustrative joint 40 of FIGS. 3D, 3E, and 5 is supported within the cavity 54 during the joining step. More particularly, as the ends 36 are melted, the material is in at least a partially liquid or molten state. Without the cavity 34, it is known that the surface tension of the molten material may support or contain the molten material and cause the joint 40 have a round or arcuate shape. However, according to the illustrative method of the present disclosure, the surface tension in the molten ends 36 does not necessarily support the formation of the joint 40, rather the cavity 54 may support the formation of the joint 40 by containing the molten material. As such, due to the cavity 54, at least a portion of a top surface 56 of the joint 40 may be generally flat or planar, rather than rounded or arcuate, because the surface tension in the joint 40 does not support the top surface 56 of the joint 40. Additionally, the dimensions or size of the joint 40 corresponds to the shape and/or size of the cavity 54.

During the illustrative joining step, the height (h₃) of the joint 40 may be reduced due to “burn back” or “burn off” of the material comprising the joint 40 (FIGS. 5 and 6). For example, the height (h₃) of the joint 40 may be reduced by approximately two to three millimeters (approximately 0.08 to approximately 0.12 inches). However, even as the height (h₃) of the joint 40 decreases, the joint 40 is still positioned within the cavity 54 during the joining step because the height of the cavity 54 is at least four millimeters (approximately 0.16 inches). As such, the cavity 54 supports the formation of the joint 40 even if burn off occurs during the joining step.

Referring to FIGS. 5 and 6, when the joint 40 has cooled and is at least partially solidified, the dies 46 are removed. The joint 40 has a generally round or cylindrical profile. The rounded shape of the joint 40 may reduce stress concentrations within the joint 40 because sharp edges or corners are eliminated. Alternatively, certain applications of the electric machine 11 may require that joint 40 have a non-round or polygonal profile and, as such, the shaped portion 50 of the dies 46 may be similarly shaped. The top surface 56 of the joint 40 is substantially planar and the joint 40 has a generally circular or elliptical cross-section. It may be understood that the conductors 30 forming the joint 40 and extending from the joint 40 into the stator stack 20 retain a rectangular cross-section during formation of the joint. As such, the conductors 30 of the illustrative stator assembly 10 have different cross-sections along the length of the conductors 30.

In one embodiment of the present disclosure, the illustrative method may include a marking step that imprints a recess or identifying indicia (e.g., a logo, numeral) in the top surface 56 of the joint 40. For example, the marking step may be performed by a marking device or die that presses down onto the top surface 56 of the joint 40 while the joint 40 is still molten. The imprint surface of the marking device includes the indicia to be transferred to the joint 40.

It may be appreciated that the joining and shaping steps may uniformly size and shape the joints 40 such that each joint 40 of the stator assembly 10 has approximately the same size and shape. Moreover, the joining and shaping steps may contribute to uniform spacing between the joints 40a and the joints 40b. As such, the radial width of the center space 16 may be uniform between joints 40a and 40b.

It should be appreciated that the shaping and joining steps may alter the shape of the joints 40 but do not machine the joint 40 to remove any material therefrom (e.g., metal shavings). As such, the illustrative shaping and joining steps may decrease the possibility of contaminating the stator assembly 10. Additionally, during the illustrative shaping step, the pressure exerted by the dies 46 is sufficient to cold work and deform the ends 36 and also may increase the surface area of the contact region 62 between the ends 36. In other words, because a greater portion of the ends 36 is in contact with each other before the joining step, the area of the joint 40 formed from the ends 36 may increase. By increasing the area of the joint 40, there is a greater area through which the current may flow during operation of the stator assembly 10. As such, the increased area of the joint 40 also dissipates more heat as current flows therethrough.

After the joint 40 is formed, the conductors 30, including the joints 40, may be further coated or otherwise sealed with a varnish or other sealant, coating, film, or epoxy (not shown) in order to stabilize the conductors 30 within the stator stack 20. The rounded profile of the joint 40 may facilitate adhesion of the varnish to the conductors 30 because the varnish may not fully adhere to sharp edges or corners.

As illustrated in FIGS. 4A-F, an alternative method of interconnecting or joining the ends 36, 38 of the conductors 30 is herein described in the following illustrative steps. The illustrative hot-working method includes a holding step, a joining step, and a shaping step performed by the coupling machine 100′. While the illustrative method is described with reference to the inner conductors 32, the outer conductors 34 are joined in the same manner.

In particular, during the illustrative holding step of the hot-working method, the holding device or tool, illustratively the clamps 42 of the coupling machine 100′, move toward the ends 36 of the inner conductors 32. The first and second holding clamps 42a, 42b move in directions 66′, 68′, respectively, to engage the ends 36 and push the ends 36 toward each other such that the inner surfaces of the ends 36 contact each other to form the contact region 62. However, the pressure exerted on the ends 36 by the holding clamps 42 may not be sufficient to cold work or deform the ends 36.

When the illustrative first and second holding clamps 42a, 42b contact the ends 36, an upper surface 64 of the holding clamps 42 may extend above the tips 60 of the ends 36. For example, the upper surface 64 may be approximately one millimeter (approximately 0.4 inches) above the tips 60 of the ends 36. Alternatively, the upper surface 64 may be coplanar with the tips 60, or otherwise positioned relative to the tips 60.

The holding clamps 42 also remain in contact with the ends 36 during the illustrative joining step. As detailed above, the torch 44 is positioned above and between the tips 60 of the ends 36 and increases the temperature of the ends 36 to weld (i.e., melt and fuse) the ends 36 together. To prepare the conductors 30 for welding, the ends 36 may be trimmed or otherwise cut or shaped. Additionally, any coating or insulation along the outer surface of the ends 36 may be removed, for example by a stripping process. The ends 36 may also be shaped or otherwise pointed prior to being melted and welded.

Referring to FIGS. 4B-4F and 5, the illustrative joint 40 is formed as the ends 36 are melted and the material of the ends 36 flows together. During the illustrative joining step, the height of the joint 40 may be reduced due to “burn back” or “burn off” of the material comprising the joint 40. For example, the height of the joint 40 may be reduced by approximately two to three millimeters (approximately 0.08 to approximately 0.12 inches).

As illustrated in FIG. 4D, the holding clamps 42 are removed while the joint 40 is still generally molten and malleable. The holding clamps 42 may move in directions 66′, 68′ away from the joint 40. Subsequently, the dies 46a, 46b of the illustrative shaping tool move toward the joint 40 along the directions 66, 68 and form the cavity 54. During the illustrative shaping step of the hot-working method, the joint 40 is generally malleable when the dies 46 of the coupling machine 100′ are applied thereto and the joint 40 deforms to the shape of the cavity 54. Illustratively, the joint 40 has a generally round and cylindrical profile and defines a circle in cross-section.

The upper surface 58 of the dies 46 may be positioned approximately one millimeter (approximately 0.4 inches) above the top surface 56 of the joint 40. The joint 40 is supported by the cavity 54, rather than by surface tension, during the shaping step. As such, the top surface 56 of the illustrative joint 40 includes at least a substantially planar, non-rounded portion. In one embodiment of the present disclosure, the illustrative hot-working method includes a marking step that imprints a recess or identifying indicia (e.g., a logo, numeral) in the top surface 56 of the joint 40 when the joint 40 is still molten. For example, a marking device or die may have an imprint surface that transfers the indicia onto the top surface 56 of the joint 40 after the illustrative joining step.

Referring to FIG. 5, when the joint 40 has cooled and is at least partially solidified, the dies 46 are removed. It may be appreciated that the illustrative hot-forming method may uniformly size and shape the joints 40 such that each joint 40 of the stator assembly 10 has approximately the same size. Additionally, the joining and shaping steps may contribute to uniform spacing between the joints 40a and the joints 40b (i.e., the radial width of the center space 16 is uniform).

After the joint 40 is formed through the illustrative hot-forming method, the conductors 30, including the joints 40, may be further coated or otherwise sealed with a varnish in order to stabilize the conductors 30 within the stator stack 20. The rounded profile of the joint 40 may facilitate adhesion of the varnish to the conductors 30.

It should be apparent that the illustrative hot-forming method may alter the shape of the joint 40 but does not machine the joint 40 to remove any material therefrom. As such, the illustrative hot-forming method may decrease the possibility of contaminating the stator assembly 10. Additionally, by not removing material, the joint 40 provides a greater area through which the current may flow during operation of the stator assembly 10. As such, the joint 40 may also dissipate more heat as current flows therethrough.

The illustrative joints 40 of the present disclosure are illustrated in FIG. 7. Conversely, the weld-end turns 82 of the stator assembly 80 illustrated in FIG. 8 are not formed according to the illustrative methods and have a substantially rectangular cross-section. As detailed above, during the shaping and the joining steps of the illustrative methods, the ends 36, 38 are forced toward each other to form the joints 40. More particularly, the radial width of the center space 16 may increase. By increasing the radial width of the center space 16, the risk of a shorting event within the stator assembly 10 may decrease. For example, the increased radial width of the center space 16 may decrease the likelihood of arcing between the phases of the stator assembly 10 and/or a short-to-ground event in the stator assembly 10. Additionally, the radial width of the center space 16 may be greater than a circumferential distance (i.e., the distance between circumferentially-adjacent joints) between the joints 40a formed by the inner conductors 32. Similarly, the radial width of the center space 16 may be greater than the circumferential distance between the joints 40b formed by the outer conductors 34.

Referring to FIG. 8, a radial width of a center space 18 between the weld-end turns 82a, 82b may be less than the radial width of the center space 16 between the joints 40a, 40b (FIG. 7). In particular, the illustrative rectangular cross-section of the joints 82 does not increase the radial width of the center space 18. As such, the risk of a shorting event may be greater for the stator assembly 80 (FIG. 8) than the illustrative stator assembly 10 (FIG. 7).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of joining a plurality of electrical conductors in an electric machine, the method comprising the steps of:
providing a core having a plurality of circumferentially spaced openings;
positioning a plurality of conductors within the openings of the core in a plurality of concentric layers, the conductors including ends extending from the core, the concentric layers including a first layer, a second layer adjacent to the first layer and spaced radially outward from the first layer, a third layer adjacent to the second layer and spaced radially outward from the second layer, and a fourth layer adjacent to the third layer and spaced radially outward from the third layer, wherein the first and second layers define an inner winding set, and the third and fourth layers define an outer winding set, the outer winding set being radially spaced apart from the inner winding set, and a center space being provided between the inner and outer winding sets;
shaping radially adjacent ends of a pair of conductors of the first and second layers of the inner winding set;
shaping radially adjacent ends of a pair of conductors of the third and fourth layers of the outer winding set;
joining the radially adjacent ends of the inner winding set to form an inner joint;
joining the radially adjacent ends of the outer winding set to form an outer joint; and
increasing a radial width of the center space between the inner and outer winding sets.

2. The method of claim 1, further comprising the steps of holding the radially adjacent ends of the inner and outer winding sets with opposing clamps, and releasing the inner and outer joints from the opposing clamps.

3. The method of claim 1, wherein the shaping steps occur prior to the joining steps.

4. The method of claim 1, wherein the joining steps occurs prior to the shaping steps.

5. The method of claim 4, wherein the shaping steps occur when a temperature of the joint is elevated.

6. The method of claim 1, wherein the shaping steps each include providing opposing forming dies, each of the forming dies includes a semi-circular shaped surface.

7. The method of claim 1, wherein at least one of the inner joint and the outer joint is generally round.

8. A method of joining a plurality of electrical conductors in an electric machine, the method comprising the steps of:
providing a core having a plurality of circumferentially spaced openings;
positioning a plurality of conductors within the openings in a plurality of concentric layers, an end of each of the conductors extending in an axial direction from the core;
applying pressure to a pair of radially adjacent ends of the conductors with a shaping tool;
joining the pair of adjacent ends of the conductors with a joining tool to form a joint; and
removing the shaping tool and the joining tool from the joint.

9. The method of claim 8, wherein the shaping tool includes opposing forming dies.

10. The method of claim 9, wherein each of the forming dies of the shaping tool includes a generally arcuate end, and the generally arcuate ends of the forming dies form a cavity for the joint.

11. The method of claim 10, wherein the joint is positioned within the cavity, and a top surface of the joint is axially below a top surface of the cavity.

12. The method of claim 8, wherein the joint is generally round.

13. The method of claim 8, wherein the joining step includes increasing a temperature of the joint.

14. The method of claim 13, wherein the removing step includes removing the shaping tool when the temperature of the joint decreases.

15. The method of claim 8, wherein the joining tool includes a welding device.

16. The method of claim 8, wherein the applying pressure step occurs before the joining step.

17. The method of claim 8, wherein the joining step occurs before the applying pressure step.

18. The method of claim 17, further comprising a holding step to support the radially adjacent ends of the conductors.

19. The method of claim 18, wherein the holding step occurs before the joining step.

20. The method of claim 19, wherein the holding step includes providing a set of opposing clamps to engage the radially adjacent ends of the conductors.

21. A method of joining a plurality of electrical conductors in an electric machine, the method comprising the steps of:
providing a core having a plurality of circumferentially spaced openings;
positioning a plurality of conductors within the openings of the core in a plurality of concentric layers, each of the conductors includes an end extending from the core, and the ends of the conductors having a first shape;
shaping the ends of the conductors with a set of forming dies to form a second shape;
joining a pair of radially adjacent ends with a joining tool to form a joint having a third shape after shaping the ends to form the second shape; and
removing the set of forming dies and the joining tool from the joint after the joining step.

22. An electric machine assembly, comprising:
a core extending in a circumferential direction and an axial direction; and
a plurality of electrical conductors supported by the core, each of the electrical conductors having a first portion extending from the core and a second portion positioned within the core, wherein adjacent first portions of the conductors form a plurality of joints, the joints having a generally circular cross-section, and the second portions of the conductors having a generally rectangular cross-section.

23. The electric machine of claim 22, wherein the plurality of joints includes an inner concentric ring of joints and an outer concentric ring of joints, the outer concentric ring is spaced radially outward from the inner concentric ring by a radial distance, and the joints of the inner concentric ring are circumferentially spaced apart from each other by an inner circumferential distance, and the joints of the outer concentric ring are circumferentially spaced apart from each other by an outer circumferential distance, the radial distance is greater than the inner circumferential distance, and the radial distance is greater than the outer circumferential distance.

24. The electric machine of claim 22, wherein each of the plurality of joints includes a generally planar top surface.

25. The electric machine of claim 22, wherein each of the plurality of joints includes a generally round cross-section.
